(19) United States
(12) Patent Application Publication
(10) Pub. No.: US 2025/0110082 A1
(43) Pub. Date: Apr. 3, 2025

(54) AN APPARATUS AND METHOD FOR CORRECTING FOR ERRORS IN A CORIOLIS METER UTILIZING TWO SUB-BUBBLE-RESONANCE SOUND SPEED OF SOUND MEASUREMENTS

(71) Applicant: Corvera, LLC, South Glastonbury, CT (US)

(72) Inventor: Daniel Gysling, South Glastonbury, CT (US)

(73) Assignee: Corvera, LLC, South Glastonbury, CT (US)

(21) Appl. No.: 18/863,785

(22) PCT Filed: Aug. 12, 2024
(86) PCT No.: PCT/US2024/041953

§ 371 Date: Nov. 7, 2024

Related U.S. Application Data
(60) Provisional application No. 63/519,583, filed on Aug. 15, 2023.

(51) Int. Cl. G01N 29/024; G01F 1/84; G01F 1/90; G01N 29/22; G01N 29/44

(52) U.S. Cl. CPC G01N 29/024; G01F 1/84; G01F 1/90; G01N 29/222; G01N 29/4481; G01N 2291/011; G01N 2291/022

(57) ABSTRACT

A method may include disposing an array of at least two sensors responsive to pressure perturbations within the process fluid along at least a portion of the length of a conduit and determining a first speed of sound of the process fluid associated with a first frequency range utilizing an output of the array of sensors. The method may include determining a second speed of sound of the process fluid associated with a second frequency range, where the second frequency range is at or above of a first acoustic cross mode frequency where the second frequency range is higher than the first frequency range and is lower than a bubble resonant frequency. Also, the method may include determining the parameter of the process fluid utilizing the first speed of sound of the process fluid and the second speed of sound of the process fluid in an optimization model.

### CROSS REFERENCE TO RELATED APPLICATIONS

This application claims priority to U.S. Provisional Patent Application Ser. No. 63/519,583 having a filing date of 15 Aug. 2023. The disclosure of the referenced patent application is disclosed herein in its entirety.

### BACKGROUND OF THE DISCLOSURE

Entrained gas is well known to cause errors in the mass flow and density of Coriolis flow meters operating on bubbly liquids. In this disclosure the terms “Coriolis meter” and “Coriolis flow meter” are used interchangeably. Several theoretical models have been developed which link errors in Coriolis meters operating on bubbly flows to a process fluid sound speed. Errors in Coriolis meters operating on bubbly liquids have also been shown to correlate with the measured speed of sound of the process fluid.

However, although a process fluid sound speed measurement can improve the accuracy of Coriolis meters operating on bubbly liquids, measuring the process fluid sound at more than one frequency can provide additional information which can be used to correct for the effect of bubbly liquids on Coriolis meters.

What is needed are practical means to determine gas void fraction and bubble size parameters in bubbly liquids within piping systems in general, and practical methods to utilize this and other information to improve the accuracy of flow meters operating on bubbly liquids in general, and Coriolis meters operating on bubbly liquids.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may be used with a that conduit includes a centerline axis along a length of the conduit and a cross axis perpendicular to the centerline axis. The method may also include disposing an array of at least two sensors responsive to pressure perturbations within the process fluid along at least a portion of the length of the conduit. The method may furthermore include determining a first speed of sound of the process fluid associated with a first frequency range utilizing an output of the array of sensors. The method may in addition include determining a second speed of sound of the process fluid associated with a second frequency range, where the second frequency range is at or above of a first acoustic cross mode frequency. The method may moreover include where the second frequency range is higher than the first frequency range and the second frequency range is lower than a bubble resonant frequency. The method may also include determining the parameter of the process fluid utilizing the first speed of sound of the process fluid and the second speed of sound of the process fluid in an optimization model. Other embodiments of this aspect include corresponding computer systems, apparatus, and computer programs recorded on one or more computer storage devices, each configured to perform the actions of the methods.

Implementations may include one or more of the following features. The method where acoustic waves associated with the second frequency range propagate in a direction with a component in a cross axis direction. The method where the parameter comprises a bubble size parameter. The method where the second speed of sound is determined utilizing a pair of acoustic transducers disposed at substantially the same axial position along the conduit. The method where the parameter comprises a correction for errors in a flow meter due to bubbly liquids. The method where the flow meter is a Coriolis flow meter. The method in which the second speed of sound is determined using the first acoustic cross mode frequency which is determined by identifying the frequency where a frequency response of a vibration of a flow tube is suppressed when subject to broad band excitation over an expected frequency range of the first acoustic cross mode frequency. The method where the flow meter is a turbine flow meter. The method where the second speed of sound is determined utilizing a single transducer operating in a pulse echo mode. The method where the optimization model is a neural network. The method where the first speed of sound is measured with an array whose aperture includes at least one flow tube of a Coriolis meter and the second speed of sound is determined using by identifying the first acoustic cross mode frequency measured on a conduit external to the at least one flow tube of a Coriolis meter. Implementations of the described techniques may include hardware, a method or process, or a computer tangible medium.

In one general aspect, a system may include a conduit that includes a centerline axis along a length of the conduit and a cross axis perpendicular to the centerline axis. The system may also include an array of at least two sensors responsive to pressure perturbations within the process fluid dispose along at least a portion of the length of the conduit. The system may furthermore include a processor configured to determine a first speed of sound of the process fluid associated with a first frequency range utilizing an output of the array of sensors and determine a second speed of sound of the process fluid associated with a second frequency range, where the second frequency range is at or above of a first acoustic cross mode frequency, where the second frequency range is higher than the first frequency range and the second frequency range is lower than a bubble resonant frequency and and determine the parameter of the process fluid utilizing the first speed of sound of the process fluid and the second speed of sound of the process fluid in an optimization model. Other embodiments of this aspect include corresponding computer systems, apparatus, and computer programs recorded on one or more computer storage devices, each configured to perform the actions of the methods.

Implementations may include one or more of the following features. The system where acoustic waves associated with the second frequency range propagate in a direction with a component in a cross axis direction. The system where the parameter comprises a bubble size parameter. The system may include a pair of acoustic transducers disposed at substantially the same axial position along the conduit and where the second speed of sound is determined utilizing output from the pair of acoustic transducers. The system where the parameter comprises a correction for errors in a flow meter due to bubbly liquids. The system where the flow meter is a Coriolis flow meter. The system where the one or more processors are further configured to determine the second speed of sound utilizing the first acoustic cross mode frequency which is determined by identifying the frequency where a frequency response of a vibration of a flow tube is suppressed when subject to broad band excitation over an expected frequency range of the first acoustic cross mode frequency. The system where the flow meter is a turbine flow meter. The system where the second speed of sound is determined utilizing a single transducer operating in a pulse echo mode. The system where the optimization model is a neural network. The system where the first speed of sound is measured with an array whose aperture includes at least one flow tube of a Coriolis meter and the second speed of sound is determined using by identifying the first acoustic cross mode frequency measured on a conduit external to the at least one flow tube of a Coriolis meter. Implementations of the described techniques may include hardware, a method or process, or a computer tangible medium.

### BRIEF DESCRIPTION OF THE DRAWINGS

FIG. 1 is a graphical representation of the decoupling ratio of a gas bubble with a liquid as a function of Inverse Stokes Number of the prior art;

FIG. 2 is a graphical representation of the speed of sound as a function of frequency for a bubbly mixture of 0.01% air and water at ambient pressure of the prior art;

FIG. 3 is a graphical representation of the mixture sound speed versus gas void fraction for bubbly air and water mixtures at ambient temperature over a range of pressures of the prior art;

FIG. 4 is a schematic representation of an array of acoustic pressure sensors installed upstream and downstream of a Coriolis meter in which the aperture of the array spans the flow tubes of a Coriolis meter in accordance with the current disclosure;

FIG. 5 is a schematic representation of a Coriolis meter configured to measure the first acoustic cross mode of the process fluid in accordance with the current disclosure;

FIG. 6 is a graphical representation of the sound speed as a function of frequency for a simulated mixture in accordance with the current disclosure;

FIG. 7 is a graphical representation of an error function used to optimize the bubble resonance frequency using simulated measured low frequency sound speed and the frequency of the first acoustic cross mode in accordance with the current disclosure;

FIG. 8 is a schematic representation of an embodiment to utilize low frequency sound speed and the frequency of the first acoustic cross mode with physics based models to correct the output of a Coriolis meter for the effects of entrained gas in accordance with the current disclosure; and

FIG. 9 is a schematic diagram of an implementation of an error correction algorithm of the current disclosure.

### DETAILED DESCRIPTION

This disclosure describes methods to measure the speed of sound of a bubbly liquid associated with at least two frequencies, or frequency ranges, that are each below the bubble resonant frequency and are sufficiently different from each other such that the comparison of the speed of sound measured at the at least two frequencies with predicted sound speeds for the a bubbly mixture predicted at the at least two frequencies provides sufficient information from which a parameter indicative of at least one of a bubble size and a measurement error from a flow meter can be determined. The approach utilizes two methods to measure a speed of sound of the bubbly mixture, 1) an interpretation of the output from an array of sensors responsive to pressure perturbations within the process fluid distributed along the flow-wise direction of a conduit to measure at least a sound speed associated with a sub-bubble-resonant sound speed associated with sound propagating essentially one-dimensionally along the axis of the a conduit, and 2) a measure or indication of the speed of sound associated with sound propagating within the conduit with a component of the propagational direction in the cross axis direction associated with a frequency, or frequency range, that is below the bubbly-resonant frequency, for example a sound propagating across the cross-sectional dimension of the conduit.

Coriolis meters defined herein are devices that measure parameters of a process fluid based on measuring and interpreting the effect that the process fluid has on the vibratory characteristics of at least one vibratory mode of a vibrating flow tube. Conventional Coriolis meters provide at least one of a measured mass flow rate of a process fluid by interpreting the effect of a process fluid on the mode shape of at least one vibrating flow tube and a measured density of the process fluid based on interpreting a measured natural frequency of at least vibrating flow tube. Typically, conventional Coriolis meters are calibrated on single-phase process fluids for which the reduced frequency, defined below, of the vibration of the flow tube is considered sufficiently low such that the effects of compressibility are considered small.

Following the theory of Hemp, the density measured by a Coriolis meter calibrated on a homogeneous and incompressible single-phase flow, but operating on a bubbly liquid, can be related to the density of the liquid phase as follows:

$${ρ}_{meas} = {ρ}_{liq} ( 1 - {K}_{d} α + {G}_{d} {f}_{red}^{2} ) \qquad ( 1 )$$

Where ρₘₑₐₛ is the measured density, ρ_{liq} is the density of the liquid phase, a is gas void fraction, f_{red} is the reduced frequency, defined below:

$${f}_{red} ≡ \frac{2 π {f}_{tube} D / 2}{{a}_{mix}} \qquad ( 2 )$$

Where f_{tube} is the vibrational frequency of the tube, D is the inner diameter of the tube, and aₘᵢₓ is the sound speed of the process fluid. The reduced frequency is a non-dimensional number that characterizes the impact of fluid compressibility on Coriolis flow meters. K_{d} is the density decoupling parameter which quantifies the effect of decoupling on the density measured by a Coriolis meter operating on of a bubbly flow. K_{d} theoretically spans from unity for fully coupled flows to three for fully decoupled conditions (1<K_{d}<3).

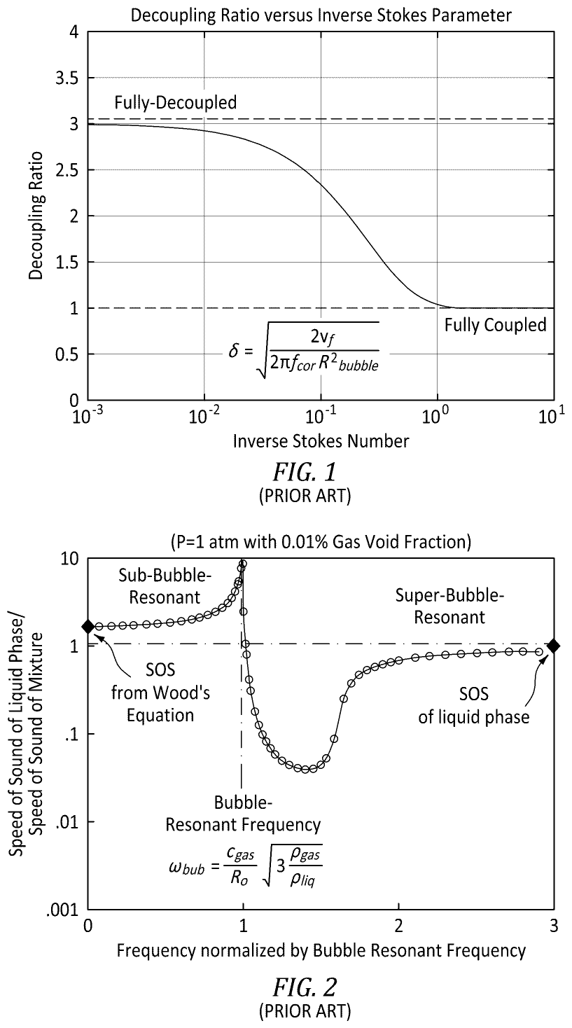

The density decoupling parameter, K_{d}, is theoretically linked to the decoupling ratio, defined as the ratio of vibrational amplitude of gas bubbles compared to that of the flow tubes, and to first order, the liquid, in the transverse oscillations of the fluid-conveying flow tubes. Bubbly liquids are said to “decouple” when the vibrational amplitude of bubbles departs from that of the liquid. FIG. 2, adapted from the prior art, shows an approximation of the decoupling ratio of bubbly liquids as a function of inverse Stokes number. The inverse Stokes number is defined as follows:

$$δ ≡ \sqrt{\frac{2 μ}{{ρ}_{liq} 2 π {f}_{tube} {R}_{bubble}^{2}}} \qquad ( 3 )$$

Where μ is the dynamic viscosity of the liquid phase, ρ_{liq} is the density of the liquid, and R_{bubble} is a representative bubble radius. The smaller the inverse Stokes number, (i.e., less viscous fluids, larger sized bubbles, higher vibrational frequency), the more decoupling that occurs. Theoretically, the maximum decoupling occurs at the inviscid limit, associated with the inverse Stokes number approaching zero. As shown in FIG. 1, in the limit of inverse Stokes number approaching zero, the decoupling ratio approaches three (K_{d}→3). For large inverse Strokes numbers, the bubbles become ‘fully-coupled’ to the liquid phase and the effects of decoupling are eliminated and K_{d} approaches unity (K_{d}≥1).

It is noted herein that a bubble size parameter is any parameter indicative of the size of bubbles within a bubble mixture. Since most bubbly mixtures contain bubbles of multiple sizes, a bubble size parameter could, for example, be indicative of the average size of bubbles in a bubble mixture with sizes span a range of sizes.

In Hemp's formulation of Equation (1), the effect of compressibility is captured by the product of G_{d}, the density compressibility parameter, and the square of the reduced frequency, f_{red}². Hemp suggests a value of G_{d}=0.25 for the density compressibility parameter. For positive values of K_{d} and G_{d}, the effects of decoupling and compressibility generate offsetting errors in the measured density of bubbly flows, with decoupling effects causing under-reporting of liquid density and compressibility effects causing an over-reporting of liquid density.

Similarly, Hemp's model predicts that the mass flow measured by a Coriolis meter operating on a bubbly liquid is related to the mass flow of the liquid as follows:

$${\dot{m}}_{meas} = {\dot{m}}_{liq} ( 1 - \frac{( {K}_{m} - 1 )}{1 - α} α + {G}_{m} {f}_{red}^{2} ) \qquad ( 4 )$$

Where Kₘ is the mass flow decoupling parameter (1<Kₘ<3) and Gₘ is the mass flow compressibility parameter. Hemp suggests a value for the mass flow compressibility parameter of Gₘ=0.5. Theoretical models in the prior art of Hemp and Zhu, predict that the density and mass flow decoupling parameters should be equal (K_{d}=Kₘ) and that the compressibility parameter is 2× or greater for mass flow compared to density (Gₘ≥2G_{d}).

It should be noted that Hemp's model is offered to provide a theoretical framework for the effect of bubbly liquids on the accuracy of Coriolis meters. Hemp's model is not offered as a quantitatively accurate description of the errors in any specific Coriolis meter.

FIG. 1 shows a model that links the decoupling ratio, and thereby the density decoupling parameter and mass flow decoupling parameter, with a bubble size parameter of a bubbly mixture, illustrating one model that relates a bubble size parameter of a bubbly mixture is linked to errors associated with a Coriolis meter operating on the bubbly mixture.

For example, determining a bubble size parameter can be used as input to a model to minimize mass flow and/or density errors in a Coriolis meter.

Additionally, as described in Gysling, “Minimally-Intrusive Approach to Quantify Impact of Gas Void Fraction on Liquid Rates Reported by Turbine Meters Operating on Liquid Outlets of Separators” presented at the 12th North American Conference on Multiphase Production, bubble size can be an important parameter impacting errors in the volumetric flow rate reported by a turbine flow meter operating on bubbly flows. This disclosure teaches using the techniques described herein to determining the dispersive characteristics of the sound propagation as an input to correct for errors in the output of turbine meters due to bubbly liquids.

### Speed of Sound of a Bubbly Liquid

The sound speed of bubbly liquids is, in general, a strong function of frequency. This frequency dependence can be broadly divided into two frequency regions determined by a bubble resonance frequency. These two regions can be defined as: 1) a sub-bubble-resonance frequency; and 2) super-bubble resonance frequency range.

The bubble resonant frequency is defined herein as the natural frequency of the “radial” resonance of a bubble or group of bubbles. The radial resonance mode is a radially symmetric oscillation of the volume of the bubble. This natural frequency is given by Minnaert's equation:

$${ω}_{0} = \frac{{c}_{gas}}{{R}_{o}} \sqrt{3 \frac{{ρ}_{gas}}{{ρ}_{liq}}} \qquad ( 5 )$$

Where Rₒ is the mean radius of the oscillating bubble or is a representative bubble radius for a group of bubbles, c_{gas} is the speed of sound in the gas contained in the bubble, and ρ_{gas} and ρ_{liq} are the ambient densities of the gas and of the liquid, respectively.

Since bubbly mixtures typically can include bubbles that span range of sizes and Rₒ is considered a representative bubble size parameter.

It is noted that for many bubbly flows of interest in conduits of interest, bubble resonant frequencies and first acoustic cross mode frequencies are below 20 kHz, a commonly used definition for the low frequency range of ultrasonic frequency range. As such, most ultrasonic flow meters operating on bubbly liquids operate within the super bubble resonant frequency range.

FIG. 2 shows the speed of sound as a function of frequency, normalized by bubble frequency, for a 0.01% gas void fraction bubbly mixture of air and water at ambient pressure adapted from the prior art. This model of the speed of sound as function of frequency is offered as a qualitative description of the speed of sound as a function of frequency for bubbly mixtures and is not offered as a quantitative description. Note that FIG. 2 plots the ratio of the speed of sound of the liquid phase to the speed of sound of the mixture, showing that the speed of sound of mixture decreases as the frequency approaches the bubble resonance frequency. As shown, the speed of sound is a strong function of frequency for frequencies near the resonant frequency of the radial volumetric resonant frequency predicted by Minnaert's equation (Equation 5). However, the speed of sound asymptotes to constant values for frequencies well-below the bubble resonant frequency and for frequencies well-above the bubble resonant frequency. These two asymptotic limits define the low frequency limit of the sub-bubble-resonance speed of sound given by Wood's equation, and the high frequency limit of the super-bubble-resonance speed of sound associated with the sound speed of the liquid phase of the mixture.

It is noted that measuring the speed of sound utilizing frequencies sufficiently below the bubbly resonant frequency can result in a measured sound speed that is representative of the low frequency limit of the sub-bubble-resonance sound speed.

It is known by those skilled in the art that Wood's equation relates the sound speed, aₘᵢₓ, and density, ρₘᵢₓ of a mixture consisting of “N” components to the volumetric phase fraction, φᵢ, density, ρᵢ and sound speed, aᵢ of each component of the mixture. The compliance introduced by the conduit, given below for a thin-walled, circular cross section conduit of diameter D and wall thickness of t and modulus of E, also influences the propagation velocity.

$$\frac{1}{{ρ}_{mix} {a}_{mix}^{2}} = {\sum }_{i = 1}^{N} \frac{{φ}_{i}}{{ρ}_{i} {a}_{i}^{2}} + \frac{D - t}{Et} \qquad ( 6 )$$

Where the mixture density, ρₘᵢₓ, is given by:

$${ρ}_{mix} = {\sum }_{i = 1}^{N} {ρ}_{i} {φ}_{i} \qquad ( 7 )$$

For bubbly liquids, Wood's equation can be expressed as a combination of a gas and liquid phase as follows:

$$\frac{1}{{ρ}_{mix} {a}_{mix}^{2}} = \frac{α}{{ρ}_{gas} {a}_{gas}^{2}} + \frac{1 - α}{{ρ}_{liq} {a}_{liq}^{2}} + \frac{D - t}{Et} \qquad ( 8 )$$

Where α is defined as the gas void fraction of the mixture, and the mixture density is given by:

$${ρ}_{mix} = α {ρ}_{gas} + ( 1 - α ) {ρ}_{liq} \qquad ( 9 )$$

The mixture speed of sound can be expressed as a function of the gas void fraction and the fluid properties and properties of the conduit as follows:

$${a}_{mix} = \frac{1}{\sqrt{{ρ}_{mix} ( \frac{α}{{ρ}_{gas} {a}_{gas}^{2}} + \frac{1 - α}{{ρ}_{liq} {a}_{liq}^{2}} + \frac{D - t}{Et} )}} \qquad ( 10 )$$

Wood's equation has been widely used to relate a measured process fluid sound speed to the gas void fraction of bubbly mixtures for ideal gases, for which the sound propagation the speed of can be expressed as:

$${a}_{gas} = \sqrt{γ R T} \qquad ( 11 )$$

### Where

$$γ = \frac{{c}_{p}}{{c}_{v}}$$

is the ratio of specific heats isentropic behavior where

$$\frac{{c}_{p}}{{c}_{v}} \approx 1.4$$

for diatomic moleculars such as hydrogen, oxygen, and nitrogen and air.

Using the above definition of the speed of sound of a gas, the following expression for the bulk modulus of the gas are equivalent:

$${ρ}_{gas} {a}_{gas}^{2} = {ρ}_{gas} γ RT = γ P \qquad ( 12 )$$

Wood's equation can account for variations conditions in which the compression and expansion of the gas is not isentropic by using a polytropic index of that is representative of the thermodynamics of the compression and expansion of the gas within the gas bubbles during sound propagation. For example, for conditions in the compression of the gas bubbles is isothermal, Wood's equations can be used to predict the sound speed by using a polytropic index of γ=1.

The physics of compressibility and expansion is governed by the heat transfer between the gas and the continuous liquid that occurs during the propagation of acoustic waves. A critical frequency can be defined where frequencies well-below the critical frequency behave isothermally and frequencies well-above the critical frequency behave isentropically.

From, K. Fu, Direct numerical study of speed of sound in dispersed air-water two-phase flow, Wave Motion 98 (November 2020). this critical frequency can be defined as:

$${f}_{crit} = \frac{{k}_{diff}}{{D}_{bubble}^{2}} \qquad ( 13 )$$

Where k_{diff} is the thermal diffusivity of dispersed phase, and D_{bubble} is represents a length scale representative of the diameter of the bubbles. Note this disclosure recognizes that bubbly liquids often contain bubbles over a range of sizes and D_{bubble} is a parameter that may represent a statistical parameter representative of a distribution of bubble sizes, for example, a mean bubble diameter.

For bubbly mixtures where the compressibility of the bubbly liquid is dominated by the volumetrically weighted compressibility of gas phase, i.e

$$\frac{α}{{ρ}_{gas} {a}_{gas}^{2}} ≫ \frac{1 - α}{{ρ}_{liq} {a}_{liq}^{2}} + \frac{D - t}{Et} \qquad ( 14 )$$

Wood's equation can be approximated as follows:

$${a}_{mix} \approx \sqrt{\frac{γ P}{{ρ}_{liq} α}} \qquad ( 15 )$$

Where gamma, γ, is the polytropic exponent governing the compressibility of the gas with the bubble during the propagation of the sound wave.

$${pv}^{γ} = constant \qquad ( 16 )$$

This disclosure utilizes the simplified expression for Wood's equation to predict the speed of sound in bubbly liquids, however, the use of any specific model for the dispersive characteristics of the speed of sound in bubbly liquids could be utilized within the scope of this disclosure

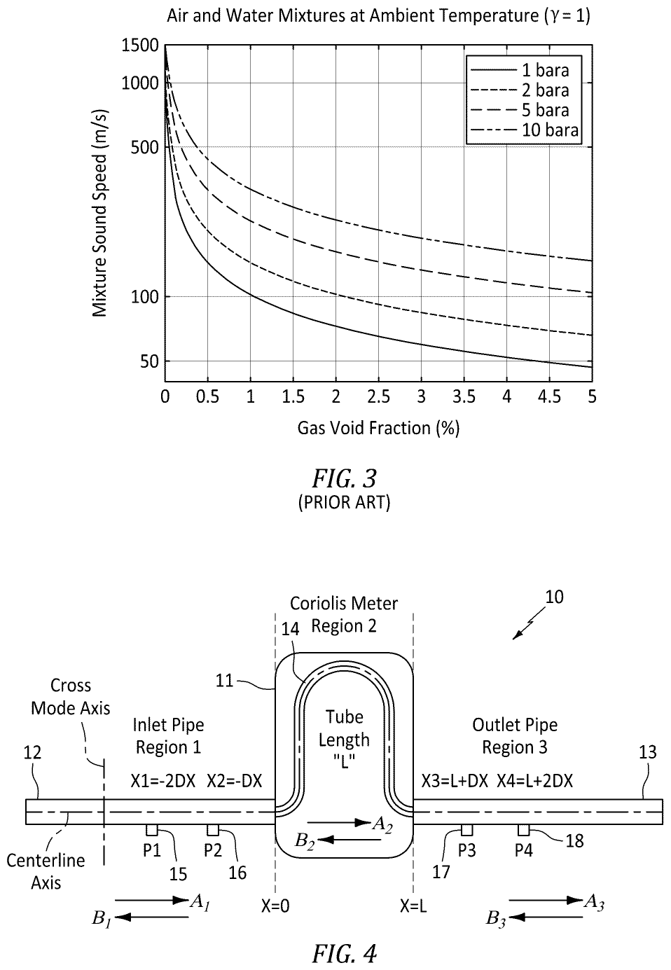

FIG. 3, from the prior art, shows the low frequency speed of sound of bubbly mixtures of air and water as a function of gas void fraction from 0% to 5% for a range of pressures at ambient temperature as predicted by Wood's Equation for isothermal sound propagation with a polytropic index of γ=1. As shown, the speed of sound of bubbly mixtures decreases rapidly with increasing gas void fraction, with the rate of decline increasing with decreasing pressure. As shown, the speed of sound can decrease an order of magnitude with the introduction of relatively small gas void fractions. It is well-known that significant reduction in the sound speed of the process fluid within a Coriolis meter can significantly increases compressibility effects in Coriolis meters operating on bubbly liquids.

Methods that utilize passive listening techniques to interpret the speed of sound for long wavelength, low frequency, essentially one-dimensional acoustics measure a speed of sound typically closely approximate the speed of sound at the lower limit of the sub-bubbly resonance speed of sound, i.e. the speed of sound governed by Wood's equation. It is noted that frequencies utilized in the determination of any sub-bubble-resonant sound speed that is measured can be included in any optimization procedure that utilizes the measured sound speed. In one embodiment of this disclosure, the frequencies used to measure the speed of sound of the one-dimensional sound speed are assumed to sufficiently low such that speed of sound interpreted utilizing these frequencies can be assumed to represent the low frequency speed of sound predicted by Wood's Equation.

For most bent tube Coriolis meters of the prior art, the ratio of the vibrational frequencies of Coriolis meters to the bubble resonance frequency is much less than 1. In this frequency range, the low frequency speed of sound governed by Wood's Equation is closely related to the speed of sound of the process fluid relevant for compressibility effects associated with the process fluid vibrating at the primary vibrational frequency of the Coriolis meter.

The low frequency speed of sound measured by passive listening techniques with an aperture spanning the length of the flow tubes of the Coriolis meter is thus well-suited to: 1) provide a means to quantify the gas void fraction; and 2) provide a measure of the process fluid sound speed relevant to assess the compressibility effects of the Coriolis meter. The speed of sound measured with passive-listening techniques utilizes sound over a low, but non-zero, frequency range. One embodiment of this disclosure teaches utilizing the mean frequency of the frequency range used as input to the beam forming techniques to determine the “low frequency” sound speed, for example this range could be in the range of 30 to 100 Hz, depending on the sound field and the aperture of the array. FIG. 4 shows a schematic of a piping network 10 including an array of acoustic pressure sensors 15-18 installed in a portion of the piping network upstream and downstream of a Region 2, a region of interest. The inlet region (Region 1) spans from X=−2DX to X=0, region 2 spans the length 11 between X=0 and X=L within Region 2 in the conduit 14, and an outlet region, Region 3, which spans from X=L to X=L+2DX. The aperture of the 4 sensor array is 4DX+L. The output of the array can be utilized to determine the low frequency sound speed of a process fluid within conduit 14 of a Coriolis meter. As shown, the piping network 10 includes a centerline axis. The centerline axis of the pipe is considered as the imaginary axis which runs longitudinally along the pipe through the midpoint of its diameter. It should be noted that the piping network 10 and conduit 14 within Region 2 can comprise any known fluid conveying device including a flow meter, a Coriolis meter, a straight pipe, or other curved pipe, etc. Herein the term centerline axis is used to denote the centerline and/or curved centerline axis of a piping network representing a straight or curved line that follows the centerline of the piping network along the length of the piping network. Also shown is the cross mode axis which is perpendicular to the centerline axis and is considered as the imaginary axis that runs through the diameter of the pipe through the midpoint of its diameter.

Time-resolved signals from an array of sensors responsive to pressure variations within a conduit of can be interpreted utilizing beamforming algorithms to determine the speed at which sound is propagating within the aperture of the array. Beamforming, as used herein, involves defining a steering vector that accounts for an expected phase shift among the measured, or in this case simulated, pressures.

The steering vector for data measured from pressure transducers 15-18 is given by the following:

$$E = \{ \begin{matrix}{e}^{- {ikx}_{1}} \\ {e}^{- {ikx}_{2}} \\ {e}^{- {ikx}_{3}} \\ {e}^{- {ikx}_{4}}\end{matrix} \} \qquad Equation 12$$

Where k is defined as the wave number,

$$k = \frac{ω}{c} ,$$

where c is the speed of sound and ω is the frequency in radians/sec. In this formulation of the steering vector, positive wave numbers are associated with waves traveling in the positive “X” direction (from left to right) and negative wave numbers are associated with waves traveling in the negative “X” direction (from right to left).

The cross spectral density matrix is composed of the cross spectral densities of the measured or simulated pressures at each location:

$$CSD = [ \begin{matrix}{P}_{11} & {P}_{12} & {P}_{13} & {P}_{14} \\ {P}_{21} & {P}_{22} & {P}_{23} & {P}_{24} \\ {P}_{31} & {P}_{32} & {P}_{33} & {P}_{34} \\ {P}_{41} & {P}_{42} & {P}_{43} & {P}_{44}\end{matrix} ] \qquad Equation 13$$

Where Pᵢⱼ=Pᵢ*Pⱼ, where Pᵢ and P*ⱼ are the Fourier transforms of the pressures at location i and the complex conjugate of the Fourier transform at location j.

Modifying the techniques described in D. H. Johnson and D. E. Dudgeon. Array Signal Processing, Concepts and Techniques. PTR Prentice-Hall, Upper Saddle River, NJ, 1993, the beamforming optimization process of the current disclosure involves adjusting the steering vector, which is a function of the speed of sound of the process fluid, to maximize the power associated with a given steering vector. The power of the array is given by the following:

$$P = {E}^{T} [ CSD ] E \qquad Equation 14$$

Where ET is the conjugate transpose of the steering vector, E.

### Acoustic Cross Modes of Coriolis Flow Tubes

The first acoustic cross mode represents the lowest order acoustic associated with the cross section of flow tubes. For a flow tube of a Coriolis meter modelled as a hard walled, circular duct, the frequency of the first acoustic cross mode is given by:

$${f}_{crossmode} = \frac{1.84}{2 π} \frac{{a}_{mix}}{{R}_{pipe}} \approx \frac{{a}_{mix}}{2 {D}_{pipe}} \qquad ( 17 )$$

Where aₘᵢₓ is the sound speed of fluid at the frequency of the first acoustic cross mode, Rₚᵢₚₑ is the radius, and Dₚᵢₚₑ is the diameter, of the Coriolis flow tube. As described in Munjal, Acoustics of Ducts and Mufflers, ISBN 0-471-84738-0, page 12, at frequencies below the frequency of the first acoustic cross mode, only plane waves, i.e. essentially one-dimensional acoustics, can propagate within conduit. At frequencies above the frequency of the first acoustic cross mode, acoustics can propagate in multiple directions within the conduit, including directions not aligned with the axis of the conduit. Typically, array processing techniques that rely on determining the speed of sound of waves propagating within along the centerline axis of a conduit or piping network are applied to frequencies well below the frequencies of the first acoustic cross mode to ensure that the speed of measured is associated with acoustic wave propagating in direction aligned with centerline of the conduit and therefore the centerline of the array of sensors.

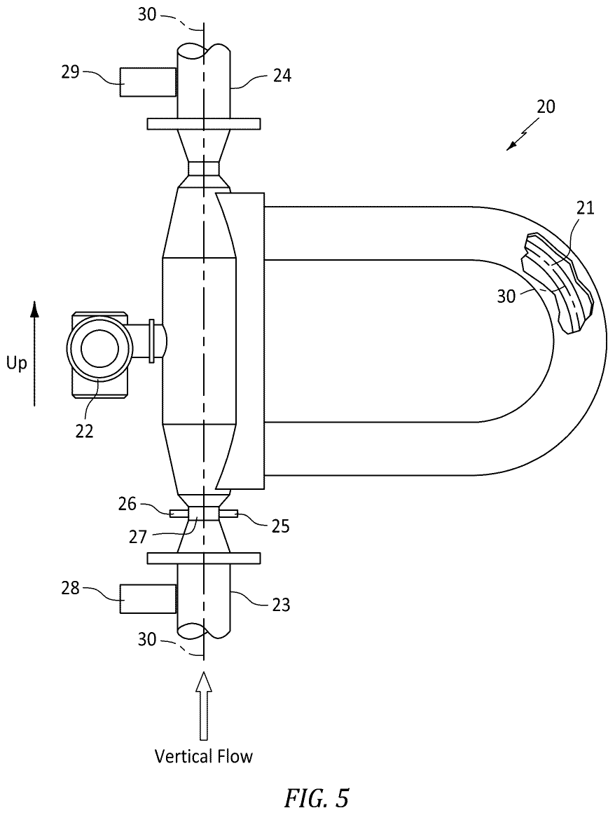

Referring to FIG. 5, the speed of sound of process fluids within flow tubes 21 of Coriolis meter 20 can be determined using the output of the array of pressure sensors 28, 29 disposed along the centerline axis 30 of the piping system including inlet pipe 23 and outlet pipe 24 respectively wherein the aperture (length) of the array follows the centerline axis of the piping network and includes the length of the flow tube 21 of Coriolis meter 20. The output of the array can be utilized to determine the low frequency sound speed of a process fluid within the conduit 14 of a Coriolis meter, and the frequency of first acoustic cross mode of a process fluid flowing through a Coriolis meter 20 could be measured within flow tubes 21 of the Coriolis meter, or in the process piping in fluid communication with the Coriolis meter, such as the inlet piping 23 or outlet piping 24 of the Coriolis meter. Additionally, the frequency of a first acoustic cross mode for the process fluid could be measured within the inlet or outlet region of a Coriolis meter such as the flow splitter or transition to the inlet or outlet flanges.

Referring still to FIG. 5, there is shown a Coriolis meter 20 which comprises a bent tube Coriolis meter is installed in a flag mounted orientation with vertical flow of process fluid in an upwards direction along centerline axis 30. As is common in the prior art, Coriolis meter 20 further includes at least one flow tube 21 and a transmitter 22 which includes a processor and output capability. Also shown, as part of a piping network, are inlet pipe 23 and outlet pipe 24. As part of the present disclosure, a first piezo electric transducer 25 and a second piezo electric transducer 26 are positioned on an inlet throat 27 of Coriolis meter 20. It should be appreciated by those skilled in the art that inlet throat 27 is hollow in cross section and it is the passage through which process fluid fluids before entering flow tube 21. The pair of piezo electric transducers 25, 26 are positioned in inlet throat 27 such that they are configured to be in acoustic contact with the process fluid during operation of Coriolis meter 20. In addition, the pair of piezo-electric acoustic transducers 25, 26 are installed 180 degrees apart from each other on inlet throat 27, in essentially the same axial position along the piping network and external to the flow tube 21. It should be appreciated that on a section of conduit, that the pair of piezo-electric acoustic transducers 25, 26 can be positioned elsewhere on or near Coriolis meter 20, such as on outlet throat 28, on inlet pipe 23, outlet pipe 24 or elsewhere without departing from the scope of the present disclosure. It should be further appreciated that the pair of piezo-electric acoustic transducers 25, 26 are configured to transmit and receive at least a component of an acoustic signal that is in a direction perpendicular to centerline axis 30, i.e. with a component in the cross axis direction with respect to the centerline axis of the piping system. In other embodiments, instead of two sensors, a single piezo electric acoustic transducer (either 25 or 26) can operate in a pulse echo mode to measure the acoustic cross mode frequency.

In one embodiment, and as one skilled in the art should appreciate, the pair of piezo-electric acoustic transducers 25, 26 can identify the speed of sound as function of frequency utilizing standard system identification techniques. For example, in one embodiment signal processing of signals from the transmitting and the receiving transducers determines the frequency at which the pressure measured at two transducers located at 180 degrees apart around the circumference of a conduit align in temporal phase. This alignment of the temporal phase indicates a standing mode representative of the first acoustic cross mode. The frequency of this this mode can be interpreted with the diameter of the conduit to determine the sound speed associated with this frequency. The pair of piezo-electric transducers 25, 26 can be electrically coupled to transmitter 22 (or other processor) equipped with software to perform the methods disclosed herein.

in another embodiment, an acoustic transducer positioned at the same axial location located 180 deg around the circumference from another acoustic transducer launches a chirped acoustic pulse with frequencies center at a specific frequency, and the receiving transducer located across the conduit, receives the acoustic pulse. In this embodiment the time of flight of the acoustic pulse is determined and provides a speed of sound associated with a frequency representative of the chirp, where this chirp frequency is well above the frequency range utilized by passive listening techniques to determine a sound speed near the lower limit of the sub-bubble-resonant sound speed, and where this chirp frequency still below the bubble-resonant frequency.

In another embodiment, a single piezo transducer could be utilized in a pulse-echo configuration to determine the speed of sound in which the transducer launches an acoustic signal and then listens for a reflected signal, where the time delay between the launch of the signal and the return signal provides a measurement of the speed of sound of associated with the frequency of the launched acoustic signal.

Measuring the frequency of the first acoustic cross mode within process piping or the housing of the Coriolis meter 11 has an advantage in terms of accessibility and the ability to readily install pressure sensors porting into the process fluid. In another embodiment, the frequency of the first acoustic cross mode can be determined by exciting transverse vibration of the conduit and utilizing clamp-on or ported pressure sensors and dynamical system identification techniques.

The speed of sound associated with the frequency of the first acoustic cross mode can also be determined within the flow tubes of the Coriolis meter. For most Coriolis meters, the frequency of the first acoustic cross mode is significantly higher than the vibrational frequency of the Coriolis meter. The commonly defined reduced frequency of a Coriolis meter approximates the ratio of the vibrational frequency to the frequency of the first acoustic cross mode as follows:

$${f}_{red} ≡ \frac{\frac{2 π {f}_{tube} D}{2}}{{a}_{mix}} = \frac{{f}_{tube}}{\frac{{a}_{mix}}{π D}} ∼ \frac{{f}_{tube}}{{f}_{crossmode}} \qquad ( 18 )$$

Thus, since Coriolis meters operating on bubbly flows typically operate with reduced frequencies less than ˜0.25, the frequency of the first acoustic cross mode is typically 4× or greater the vibrational frequency of the flow tube.

For applications for which the first acoustic cross mode remains below the bubble resonance frequency, the difference in the speed of sound determined for low frequencies, such as the sound speed determined utilizing passive listening techniques, and the sound speed determined by identifying the frequency of the first acoustic cross mode provides a means to estimate the bubble resonant frequency, and from the bubble resonant frequency, determine the bubble size.

There are many additional methods to identify the frequency of the first acoustic cross mode of a bubbly liquid within a conduit. In one embodiment, a pressure sensor is installed within the conduit and the conduit is vibrated in transverse direction over a range of frequencies. The frequency of the first acoustic cross mode can be determined by identifying the frequency at which the ratio of the output of the pressure transducer to the input vibration amplitude reaches maximum.

In another embodiment, the method to identify the frequency of the first acoustic cross mode within the flow tubes of a Coriolis meter is described by Zhu, H. et al., “A method for ascertaining a physical parameter of a gas-charged liquid”, US Patent Application 2022/20082423 A1 can be used. In this embodiment, the frequency of the first acoustic cross mode can be identified by exciting vibration in a cross axis direction of a conduit within a piping network with white noise over a frequency range that includes the frequency of the first acoustic cross mode of the fluid contained within the conduit and identifying the frequency at which the response, i.e. the measured vibrational amplitude of the conduit, is suppressed due to the resonance of the first acoustic cross mode of the fluid within the conduit. In this embodiment, the term “suppressed” response refers to the measured amplitude of the vibratory response of the conduit at the frequency of the first acoustic cross mode being substantively reduced compared to other frequencies in proximity to the frequency of the first acoustic cross mode when the conduit is subjected to forced broad band excitation over an expected frequency range that includes the first acoustic cross mode and other proximal frequencies. By knowing the cross sectional dimension of the flow tube and the frequency response of the suppressed mode, the sound speed at the frequency of the first acoustic cross mode of the fluid within the conduit can be determined. This approach can be particularly advantageous for Coriolis meters because it can be implemented utilizing electronics typically available in prior art Coriolis meters. For example, the drive coil of a prior art Coriolis meter can be utilized to impart broad band excitation of a cross axis vibration, and the pick-off coils can be used to measure the response of the tubes, as described in US Patent Application 2022/20082423 A1. It is noted that the frequency of the first acoustic cross mode will vary with speed of sound of the process fluid, where the sound speed of the process fluid varies with at least the gas void fraction of the process fluid.

### Simple Parameter Model of the Sub-Bubble-Resonance Sound Speed

In one embodiment of the current disclosure, the sub-bubble-resonance speed of sound as a function of frequency is assumed to a form as follows:

$$SOS ( f ) = {a}_{mix} * abs ( 1 - {( \frac{f}{{f}_{bub}} )}^{2} + 2 ξ ( \frac{f}{{f}_{bub}} ) i ) \qquad ( 19 )$$

Where aₘᵢₓ is the sound speed of the mixture described by Wood's equation. With this model, bubble resonant frequency can be identified using the speed of sound measured at two or more sub-bubble-resonance frequencies. In this embodiment, a low frequency speed of sound, a_{low}, is measured over a known low frequency range with representative frequency of flow, as well as the frequency of the first acoustic cross mode, f_{crossmode}. For purposes of this disclosure, the term low frequency range is relative to the first acoustic cross mode wherein low frequency is substantially lower than the frequency of the first acoustic cross mode. For simplicity in this embodiment, the measured low frequency sound speed is assumed to be equal to the speed of sound in the limit of low frequency calculated by Wood's equation. A measured acoustic cross mode frequency can then be used to determine the speed of sound of a first acoustic cross mode as follows:

$${a}_{crossmode} = \frac{π D}{1.84} {f}_{crossmode} \qquad ( 20 )$$

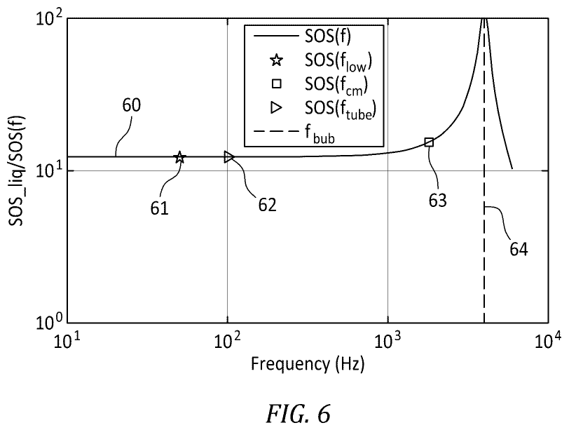

Referring to FIG. 6, there is shown the sub-bubble-resonance sound speed as a function of frequency 60 for a bubble mixture in the flow tubes a Coriolis meter simulated with the models described herein above with the parameters listed in Table 1 below. The sound speed at the low frequency range 61, the Coriolis flow tube vibrational frequency 62, and the frequency of the first acoustic cross mode 63 are each indicated on FIG. 6.

As shown in this simulation, the simulated measured low frequency sound speed 61 closely matches the sound speed at the low frequency limit, and the simulated sound speed at the first acoustic cross mode 63 is significantly different that the sound speed at the low frequency limit. The degree to which these two sound speeds differ depends on the parameters of the Coriolis meter and the process fluid. However, this example provides an illustration of a situation in which the sound speed associated with the first acoustic cross mode 63 is predicted to be ˜20% lower than the sound speed at the low frequency limit.

TABLE 1
Parameters for Simulation Shown in FIG. 6

| | Pressure | | |
|---|---|---|---|
| GVF (%) | (bara) | amix (fps) | fred |
| 0.10 | 2.00 | 321.00 | 0.082 |
| Ftube | Fcrossmode | acrossmode | fbub |
| (Hz) | (Hz) | (fps) | (Hz) |
| 100.00 | 1801.00 | 256.00 | 4000.00 |
| aliq | | mu | Flow |
| (ft/s) | zsi | (mPa-s) | (Hz) |
| 3936 | 0.05 | 3.00 | 50.0 |
| D (in) | Rbub (mm) | invStokes | Kd |
| 1.00 | 1.15 | 0.08 | 2.43 |

The sound speed at the low frequency range 61 and the frequency of the first acoustic cross mode 63 can be used, in conjunction with other typically known parameters of the fluid and the Coriolis meter, to determine and optimized bubble resonance frequency 64.

The sound speed at the low frequency range 61 and the frequency of the first acoustic cross mode 63 values can then be utilized along with other parameters of the bubbly process fluid flow and the Coriolis meter to solve for the bubble resonance frequency by minimizing the error function given below as a function a bubble resonance frequency:

$$error ( {f}_{bub} ) = {( {a}_{crossmode} - {a}_{mix} * abs ( 1 - {( \frac{{f}_{crossmode}}{{f}_{bub}} )}^{2} + 2 ξ ( \frac{{f}_{crossmode}}{{f}_{bub}} ) i ) )}^{2} \qquad ( 21 )$$

Where a_{crossmode} is given in terms of the measured cross mode frequency as described above.

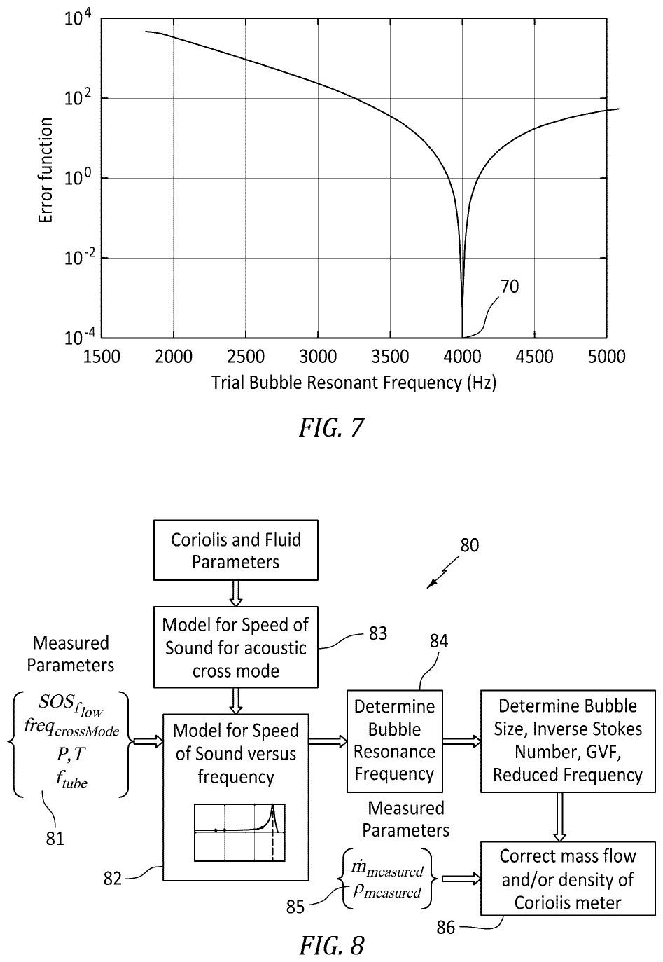

Referring to FIG. 7, there is shown a graphical representation of the error function of Equation 15 used to optimize the bubble resonance frequency using simulated measured low frequency sound speed and the frequency of the first acoustic cross mode. In this optimization the allowable range of bubble resonance frequencies was restricted to frequencies above the measured cross mode frequency, consistent with the assumption that acoustic cross mode frequency is below the bubble resonance frequency. As shown, the optimization provides a unique optimized value for the bubble resonance frequency 70 equal to the bubble resonant frequency utilized to generate the simulated measured cross mode resonance frequency. With the bubble resonant frequency determined, Minnaert's equation (Equation 5) can be used to determine an estimate of the bubble size.

As described above, bubble size is an important parameter which influences the inverse Stokes parameter of a bubbly fluid within a vibration flow tube of a Coriolis meter. Typically, the viscosity and the density of the process fluid is either known or can be well-estimated. Thus, by measuring the speed of sound associated with two sub-bubble-resonance frequencies, the bubble resonant frequency can be determined, enabling the bubble size to be determined, enabling the inverse Stokes number to be determined. The inverse Stokes number provides a means to determine determine a parameter indicative of decoupling ratio. In one embodiment, the determined decoupling ratio is used as an input to an optimization procedure to minimize the errors of a Coriolis meter operating on bubbly liquids.

One embodiment of the current disclosure enables the determination of: 1) the gas void fraction; 2) the reduced frequency; and 3) the decoupling ratio. It should be recognized by those skilled in the art that this information can be used in analytical or empirical models to correct for the effects of entrained gases on Coriolis meters operating on bubble liquids.

Referring to FIG. 8 there is shown a schematic diagram 80 of an embodiment of the current disclosure to utilize measured parameters 81 including low frequency sound speed and the frequency of the first acoustic cross mode as well and pressure, temperature and the frequency of the tube of the Coriolis meter as input into physic-based optimization model 82 for modelling speed of sound versus frequency. Model 82 further uses properties from the Coriolis meter, and the process fluid as inputs to physics based optimization model 83 to use the speed of sound to determine the acoustic cross mode as disclosed herein above. The output of model 83 is also used as input to model 82 to determine the bubble resonance frequency 84 and the bubble size, inverse Stokes number, gas void fraction and reduced frequency as disclosed in detail herein above. These parameters are used, along with measure parameters 85 from the Coriolis meter to correct the output of Coriolis meters for the effects of entrained gas 86.

The approach outlined in FIG. 8 can be utilized for Coriolis meter with flow tubes with multiple driven vibratory frequencies, and for Coriolis meters with flow tubes of multiple geometries.

In another embodiment of the current disclosure, it should be appreciated by those skilled in the art that the sound speeds measured and the frequencies at which the respective sound speeds were measured, can be used an input to a neural network, or other error minimizing algorithm, and used to minimize errors in Coriolis meters operating on bubbly fluids. An aspect of any embodiment of the current disclosure is to provide measurements that describe the speed of sound of the bubbly liquid at two or more frequencies.

One of the advantages of the embodiment which utilizes a low frequency sound speed measurement (using for example passive-listen with a wide aperture array) and a method to identify the first acoustic cross mode is the that the lower frequency sound speed is a good approximation to the low frequency limit of the sound speed propagation velocity and the frequency of the first acoustic cross mode is typically much closer to the bubble frequency, enabling the two measurements to be at sufficiently different frequencies to enable a good estimate of the bubble frequency.

It is important to note that although this disclosure provides a means to utilized physics-based models to correct the output of a Coriolis meter, neural networks and other optimization techniques can develop empirically based modes to leverage the influence of a difference in the two sound speed measurement on the errors in a Coriolis meter. For example, if the low frequency sound speed and the sound speed determined from the first acoustic cross mode are relatively similar but the frequencies at which they were measured is relatively large, this implies relatively high bubble frequency and therefore small bubbles and relatively small decoupling ratios.

Conversely, a relatively large difference in sound speed and a relatively small difference in frequency implies a relatively low bubble frequency, and therefore relatively large bubbles and relatively high decoupling ratios.

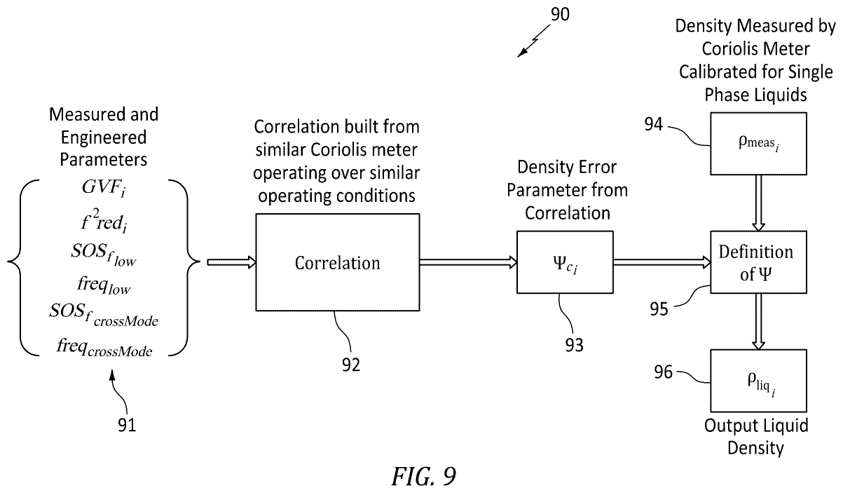

Referring next to FIG. 9, there is shown schematic diagram of an error correction algorithm 90 where the low frequency speed of sound, representative low frequency, acoustic cross mode frequency, and sound speed measured at the acoustic cross mode frequency are used as input 91 to a correlation 92 that can be used to correct the density measured by a Coriolis meter. FIG. 9 further illustrates an error correction approach that utilizes a measured gas void fraction, a measured reduced frequency, and the measured low frequency sound speed and associated frequencies for the low frequency sound speed determined using beam forming techniques from a long aperture array and the measured sound speed associated with the first acoustic cross mode and the frequency of the first acoustic cross mode. Also shown in the figure is Ψ, a density error parameter 93 as output from the correlation 92 wherein Ψ is defined as:

$$Ψ ≡ 1 - \frac{{ρ}_{meas}}{{ρ}_{liq}} \qquad ( 22 )$$

Where ρ_{liq} is the density of the liquid and ρₘₑₐₛ is the density 94 reported by a Coriolis meter operating on a bubbly mixture but calibrated on a single phase, essentially homogeneous liquid with a small reduced frequency, f_{red}<<1, the reduced frequency. Using the ρₘₑₐₛ from the Coriolis meter at step 95, the error correction algorithm 90 outputs ρ_{liq} is the density of the liquid 96.

Note that there are numerous embodiments of this invention in which the sound speed and frequencies approaching a low frequency limit, and the first acoustic cross mode can be utilized to correct for errors in the mass flow and/or density of a Coriolis meter operating in bubble flow.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more”. Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for determining a parameter of a process fluid flowing in a conduit, the process fluid comprising a bubbly fluid, the method comprising:
wherein the conduit includes a centerline axis along a length of the conduit and a cross axis perpendicular to the centerline axis;
disposing an array of at least two sensors responsive to pressure perturbations within the process fluid along at least a portion of the length of the conduit;
determining a first speed of sound of the process fluid associated with a first frequency range utilizing an output of the array of sensors;
determining a second speed of sound of the process fluid associated with a second frequency range, wherein the second frequency range is at or above of a first acoustic cross mode frequency;
wherein the second frequency range is higher than the first frequency range and the second frequency range is lower than a bubble resonant frequency; and
determining the parameter of the process fluid utilizing the first speed of sound of the process fluid and the second speed of sound of the process fluid in an optimization model.

2. The method of claim 1 wherein acoustic waves associated with the second frequency range propagate in a direction with a component in a cross axis direction.

3. The method of claim 2 wherein the parameter comprises a bubble size parameter.

4. The method of claim 2 wherein the parameter comprises a correction for errors in a flow meter due to bubbly liquids.

5. The method of claim 4 wherein the flow meter is a Coriolis flow meter.

6. The method of claim 4 wherein the flow meter is a turbine flow meter.

7. The method of claim 3 where the second speed of sound is determined utilizing a pair of acoustic transducers disposed at substantially the same axial position along the conduit.

8. The method of claim 2 wherein the second speed of sound is determined utilizing a single transducer operating in a pulse echo mode.

9. The method of claim 1 wherein the optimization model is a neural network.

10. The method of claim 1 wherein the first speed of sound is measured with an array whose aperture includes at least one flow tube of a Coriolis meter and the second speed of sound is determined using by identifying the first acoustic cross mode frequency measured on a conduit external to the at least one flow tube of a Coriolis meter.

11. The method of claim 5 in which the second speed of sound is determined using the first acoustic cross mode frequency which is determined by identifying the frequency where a frequency response of a vibration of a flow tube is suppressed when subject to broad band excitation over an expected frequency range of the first acoustic cross mode frequency.

12. A system for determining a parameter of a process fluid flowing in a conduit comprising:
the conduit includes a centerline axis along a length of the conduit and a cross axis perpendicular to the centerline axis;
an array of at least two sensors responsive to pressure perturbations within the process fluid dispose along at least a portion of the length of the conduit;
a processor configured to:
determine a first speed of sound of the process fluid associated with a first frequency range utilizing an output of the array of sensors;
determine a second speed of sound of the process fluid associated with a second frequency range, wherein the second frequency range is at or above of a first acoustic cross mode frequency, wherein the second frequency range is higher than the first frequency range and the second frequency range is lower than a bubble resonant frequency; and
determine the parameter of the process fluid utilizing the first speed of sound of the process fluid and the second speed of sound of the process fluid in an optimization model.

13. The system of claim 12, wherein acoustic waves associated with the second frequency range propagate in a direction with a component in a cross axis direction.

14. The system of claim 13, wherein the parameter comprises a bubble size parameter.

15. The system of claim 14, further comprising a pair of acoustic transducers disposed at substantially the same axial position along the conduit and wherein the second speed of sound is determined utilizing output from the pair of acoustic transducers.

16. The system of claim 13, wherein the parameter comprises a correction for errors in a flow meter due to bubbly liquids.

17. The system of claim 16, wherein the flow meter is a Coriolis flow meter.

18. The system of claim 17, wherein the one or more processors are further configured to determine the second speed of sound utilizing the first acoustic cross mode frequency which is determined by identifying the frequency where a frequency response of a vibration of a flow tube is suppressed when subject to broad band excitation over an expected frequency range of the first acoustic cross mode frequency.

19. The system of claim 16, wherein the flow meter is a turbine flow meter.

20. The system of claim 13, wherein the second speed of sound is determined utilizing a single transducer operating in a pulse echo mode.

21. The system of claim 12, wherein the optimization model is a neural network.

22. The system of claim 12, wherein the first speed of sound is measured with an array whose aperture includes at least one flow tube of a Coriolis meter and the second speed of sound is determined using by identifying the first acoustic cross mode frequency measured on a conduit external to the at least one flow tube of a Coriolis meter.
